(19) United States
(12) Patent Application Publication
(10) Pub. No.: US 2026/0257815 A1
(43) Pub. Date: Sep. 3, 2026

(54) LIGHTER THAN AIR VEHICLE AND A COMMUNICATION SYSTEM COMPRISING THE SAME

(71) Applicant: AVEALTO LTD, London (GB)

(72) Inventor: Manuel Esperon MIGUEZ, Isleworth (GB)

(21) Appl. No.: 18/878,346

(22) PCT Filed: Jun. 28, 2023
(86) PCT No.: PCT/GB2023/051688

§ 371 Date: Dec. 23, 2024

(30) Foreign Application Priority Data
Jun. 28, 2022 (GB) 2209475.9

(51) Int. Cl. B64U 10/30; B64U 50/19; B64U 101/20; G05D 1/46; G05D 1/611; G05D 105/40

(52) U.S. Cl. CPC B64U 10/30; B64U 50/19; G05D 1/46; G05D 1/611; B64U 2101/20; B64U 2201/10; G05D 2105/40

(57) ABSTRACT

A lighter than air vehicle comprising a steering and propulsion system, and a control system, the control system comprising one or more sensors for monitoring the position and orientation of the vehicle and being configured to control operation of the steering and control system based on sensed data, wherein the control system is configured to substantially maintain the vehicle within a predetermined distance of a predetermined point by: defining a first sphere having the predetermined point at its centre; monitoring the orientation of the vehicle and its position relative to the first sphere; and controlling the steering and propulsion system in dependence on the position of the vehicle relative to the first sphere.

The present disclosure relates to a lighter than air vehicle. In particular, to such a vehicle suitable for use in a high-altitude pseudo satellite communications system. It further relates to such a communications system comprising the vehicle.

The world is undergoing an extraordinary technological revolution in satellite and high-altitude communications. A dramatic increase in broadband capacity across the globe, spurred by new technologies is bringing the promise of reliable and affordable broadband connectivity to the hardest-to-reach corners of the Earth.

However, it is apparent that new technologies are required to enable new capabilities and applications in areas already connected to the global network, and to help drive down access costs for many people. Over 3 billion people do not have access to the Internet today and are essentially cut off from modern society and all the benefits of health, education, equality and financial stability and advancement that it can bring.

Due to their coverage, reliability, mobility, and flexibility, increasing consideration is being given to space-based technologies as a means of expanding the reach and density of the global Internet.

To date, however, no commercially viable solution has been implemented to allow for sufficiently widespread use.

Geosynchronous Orbit Satellites (GEOSats) orbit directly over the equator at an altitude of around 36,000 kilometers (22,000 miles). Their orbital speed allows them to remain over the exact same position as the earth turns. This allows a ground-based antenna to be fixed in position to send and receive radio signals to and from the satellite. A GEOSat now costs over US $350M to build and launch into geosynchronous orbit, with launch failures a constant risk. Most GEOSATs have an on orbit lifetime of around 8 to 12 years. GEOSats cannot be serviced or upgraded while on station. Due to the orbital distance from earth, a GEOSat signal will have a very high latency or propagation delay. This is highly noticeable on voice calls transmitted by satellite. This 500 millisecond (½ second) delay also reduces the effectiveness of error correction for data transmissions which can severely limit the capacity of Internet bandwidth.

Low Earth Orbit Satellites (LEOSats) travel in orbit closer to the earth. To maintain orbit they must travel at a higher speed and change their position relative to the ground very quickly. A LEOSat requires less signal strength to send a radio signal to the earth since it is orbiting closer to the earth than a GEOSat, however LEOSats support much less bandwidth than GEOSats. Moreover, a large number of LEOSats are needed to provide complete coverage so that one is always overhead. Current examples include Iridium and Globalstar, which each operate a constellation of LEOSats. Each LEOSat spends a large part of its orbit over areas where there are few or no potential users and can only provide a very small amount of bandwidth per satellite. More sophisticated LEOSats for telecom are being developed, but the cost of these networks will be many billions of dollars.

High Altitude Platform (HAP) vehicles are known. These unmanned vehicles, which may be airplanes or airships, fly above currently controlled airspace at an altitude of approximately 20 km. HAP vehicles are much lower in cost as compared to GEOSats and LEOSats. However, to date, no appropriate solution based on the use of HAP vehicles has been proposed.

The present invention arose during work to provide an improved communications system, which may be implemented in a cost-effective manner and address the shortcomings of the prior art.

Representative features are set out in the following clauses, which stand alone or may be combined, in any combination, with one or more features disclosed in the text and/or drawings of the specification.

According to the present invention in a first aspect, there is provided a lighter than air vehicle as recited by Claim 1.

By the present invention, a unique control methodology is implemented, which may be used to maintain the vehicle at a substantially continuous position for a desired period of time.

The vehicle is preferably an airship.

The first control protocol preferably comprises operating the steering and propulsion system to rotate the vehicle about one or more of its axes to point the vehicle towards the predetermined point, and subsequently operating the steering and propulsion system to propel the vehicle towards the predetermined point.

With such an arrangement, the vehicle may be rotated, preferably substantially on the spot, to acquire a desired orientation (pointing to the predetermined point) before being propelled towards the predetermined spot. Travel of the vehicle between its start and end points will be direct and will preferably occur substantially entirely along a substantially straight path.

It must be noted that path correction may be implemented under the first control protocol, following rotation and the implementation of propulsion, to compensate for external factors such as wind acting on the vehicle to push it off path. Path correction may, for example, be implemented by use of differential thrust. In absence of such external factors the path will be a straight line. Regardless of whether correction is required or not, under the first control protocol, following initial rotation, the vehicle will be substantially maintained pointing towards the predetermined point at all times.

The arrangement is such that there is no thrust applied to propel the vehicle until the vehicle has been rotated. It must be noted that rotation may occur by the application of differential thrust. The vehicle may be propelled using linear or asymmetric thrust.

The first control protocol may additionally or alternatively comprise varying thrust in dependence on the distance of the vehicle from the predetermined point.

The second control protocol preferably comprises setting a navigation path to the predetermined point, which comprises one or more intervening waypoints, and operating the propulsion and steering system to follow the navigation path.

With such an arrangement, in contrast to the second protocol, linear or asymmetric thrust will be applied prior to any rotation of the vehicle. The vehicle will begin movement from its start point before it starts to turn.

The control system may be configured to define a second smaller sphere having the predetermined point at its centre, and to control the steering and propulsion system in dependence on the position of the vehicle relative to the first and second spheres.

The control system is preferably configured to implement a third control protocol when the vehicle is within the second sphere. The third control protocol is preferably different to each of the first and second control protocols.

The third control protocol preferably comprises shutting off the propulsion and steering system. Thereby, in contrast to the first and second protocols discussed above, the vehicle is not propelled away from its starting point.

Under the third control protocol, only the altitude of the vehicle will be maintained. There is preferably a buoyancy control system provided for maintaining buoyancy of the airship in all of the control protocols.

The first sphere may have a radius of 500 m or less. The second sphere may have a radius of 250 m or less.

The vehicle preferably further comprises a communications payload that is configured for providing a communications relay service with a ground station within one or more or all of the C band, the X band, the Ku band, the K band, and the Ka band.

By provision of such a communications payload, communications occur in the frequency bands associated with GEOSats.

The vehicle may be used as part of a communications system that offers a cost-effective alternative to prior art satellite communications systems. The substantially constant position of the vehicle and use of a communications payload providing a communications relay service with a ground station within one or more or all of the C band, the X band, the Ku band, the K band, and the Ka band, allows the use of the system with existing satellite ground stations, without reconfiguration, the vehicle effectively mimicking a GEOSat.

The communications system may comprise at least one of the vehicles as defined above, which, in use, is maintained at a substantially constant position (within the first sphere) at an altitude of 15 km to 22 km. The communications system may comprise a plurality of the airships.

The altitude makes use of airspace that is not in widespread use, whilst also significantly reducing latency.

The communications payload preferably comprises an antenna array, which is mounted to the vehicle via a three-axis gimbal for maintaining a substantially constant orientation of the antenna array relative to the earth.

The communications system may be configured to provide a communications relay service in any possible combination of the stated bands, i.e., at any desired frequencies between 4 and 40 GHz.

The vehicle preferably maintains its position (i.e. remains within the first sphere) for at least 12 hours. It may maintain its position for at least 24 hours, at least a week, at least a month, or even at least a plurality of months.

The communications payload may be of “bent pipe” architecture, whereby the signal undergoes frequency translation, or may be regenerative, whereby the signal is received and re-generated. In either instance, the purpose is to emulate operation of a GEOSat.

The communications payload is preferably configured to transmit signals at a predetermined power level, such that when the signal reaches the receiver on the ground it has a power level equivalent to that of a signal received from a Geosynchronous Orbit Satellite.

This signal strength matching with GEOSats has several benefits. The signal is not of a strength to overpower signals from such satellites. Moreover, the ground station receives signals without distinction between signals received from GEOSats or the vehicle of the present invention.

The communications payload may be configured to receive a signal at a first power level and to transmit the signal at a second power level that is lower than the first power level.

Since the received signal is travelling a far shorter distance to reach the vehicle than an equivalent signal received by GEOSats, the received signal at the vehicle has a greater signal strength. Accordingly, the communications payload may be arranged to transmit a signal at a reduced strength to the received signal, whilst matching the signal strength at the ground level of the transmitted signal of GEOSats at ground level.

The communications payload may be configured such that the ground transmit area covered by the vehicle can be modified by switching off one or more antennas of the array. Such an arrangement provides an effective means of reducing interference.

Further, preferred, features are presented in the dependent claims.

Non-limiting embodiments of the invention will now be discussed with reference to the following drawings:

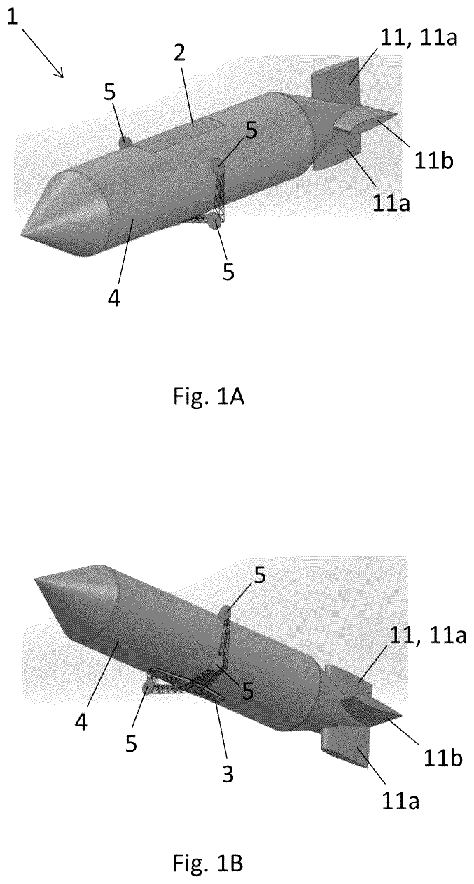

FIGS. 1A and 1B show top and bottom perspective views of an airship, which comprises a lighter than air vehicle according to the present invention;

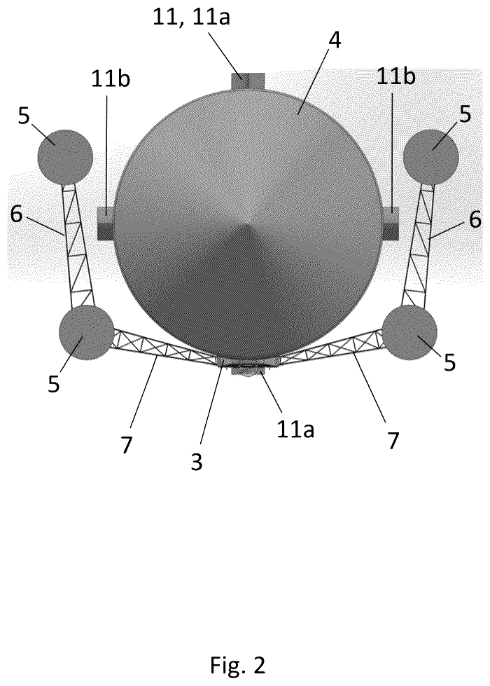

FIG. 2 shows a front view of the airship of FIGS. 1A and 1B;

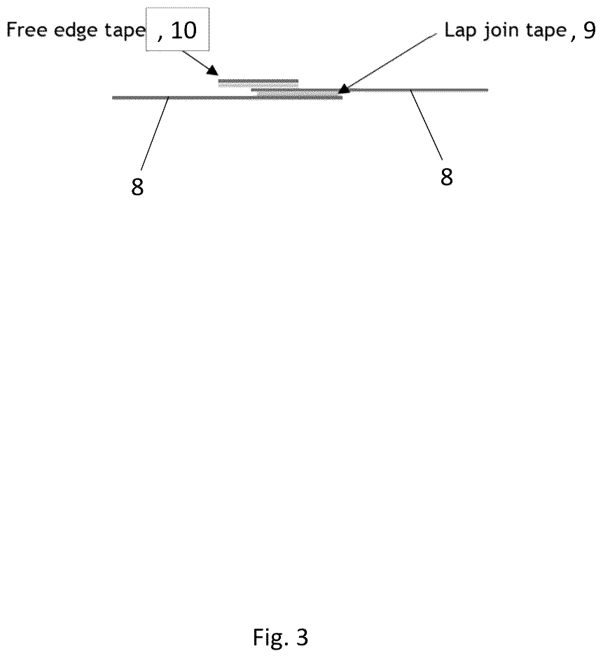

FIG. 3 shows a construction detail of an outer envelope of the airship of FIGS. 1A and 1B;

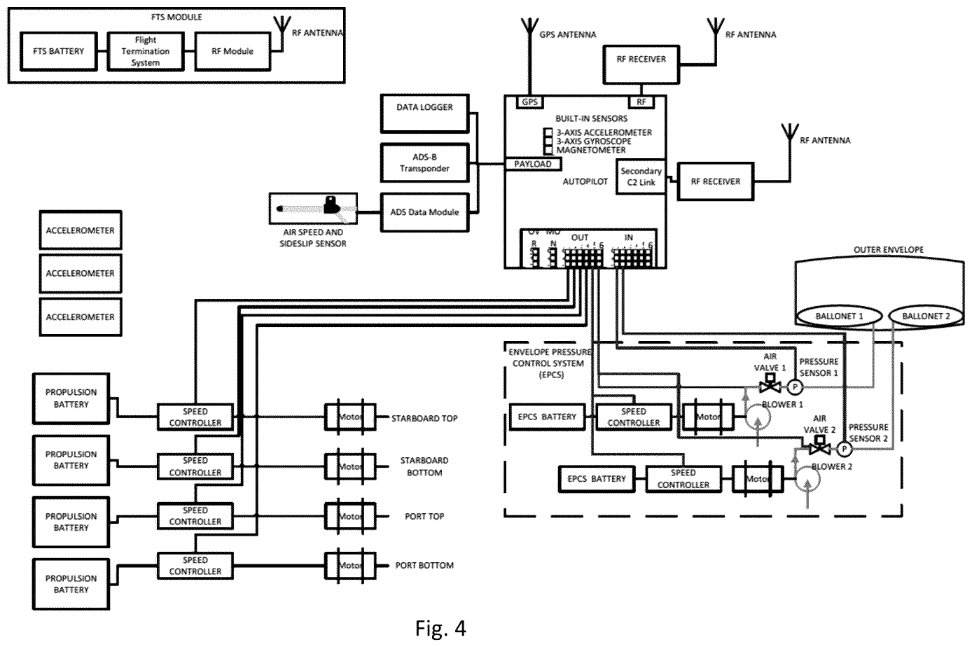

FIG. 4 shows an exemplary avionics system architecture for the airship of FIGS. 1A and 1B;

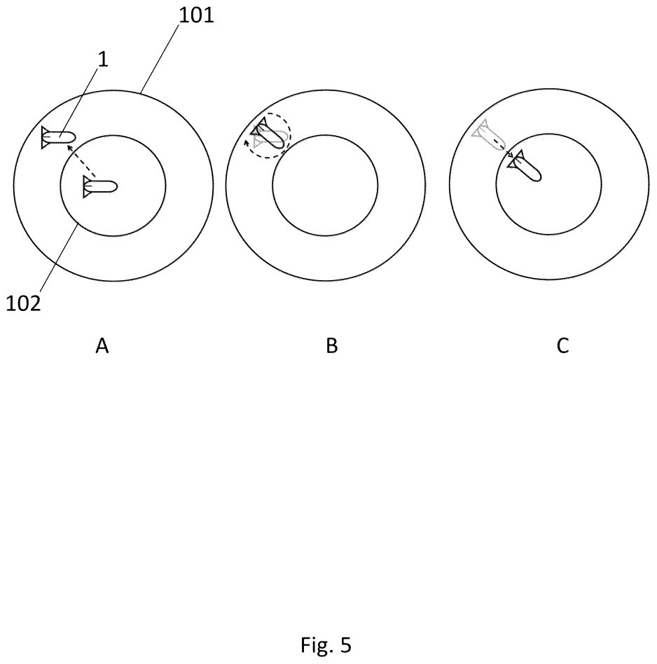

FIG. 5 shows, in plan view, an operational sequence under a first control protocol; and

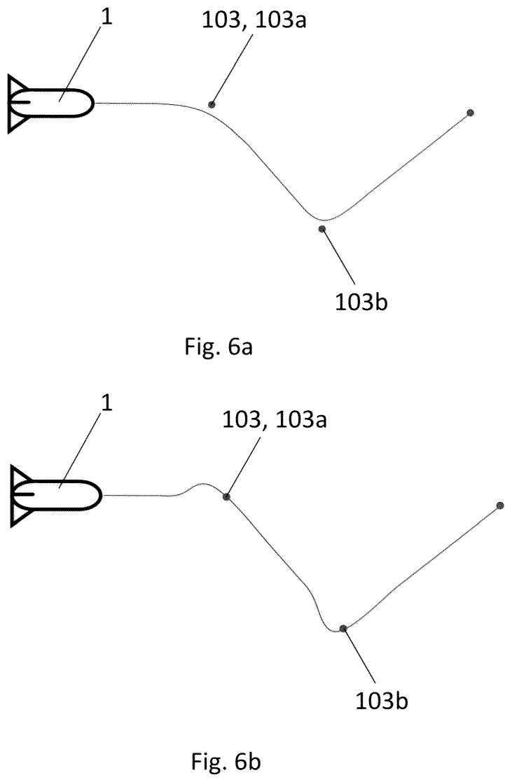

FIGS. 6a and 6b show, in plan view, exemplary movement of the vehicle in accordance with a second control protocol.

In broadest terms, there is provided a lighter than air vehicle 1 comprising a steering and propulsion system, and a control system, the control system comprising one or more sensors for monitoring the position and orientation of the vehicle and being configured to control operation of the steering and propulsion system based on sensed data, wherein the control system is configured to substantially maintain the vehicle within a predetermined distance of a predetermined point by: defining a first sphere having the predetermined point at its centre; monitoring the orientation of the vehicle and its position relative to the first sphere; and controlling the steering and propulsion system in dependence on the position of the vehicle relative to the first sphere.

There is preferably further provided a communications system comprising at least one vehicle, which, in use, is maintained at a substantially constant position (within the first sphere) at an altitude of 15 km to 22 km, and which comprises a communications payload for providing a communications relay service with a ground station within one or more or all of the C band, the X band, the Ku band, the K band, and the Ka band.

The vehicle is preferably configured to maintain its substantially constant position for at least 12 hours.

The communications system may comprise a plurality of the airships. It may, for example, include tens of the airships.

It is to be noted that whilst the vehicle is described herein primarily in respect of its use within a communications system, and particularly a communications system for providing pseudo satellite communications, it may find utility otherwise. It is not to be limited for use in such communications system.

With reference to FIGS. 1A and 1B and 2, there is shown a lighter than air vehicle 1 suitable for use in the system. The lighter than air vehicle 1 comprises an airship. Whilst an airship is the preferable form of vehicle and will be described in detail herein, it should be appreciated that alternative arrangements may be provided within the scope of the invention that comprise alternative forms of lighter than air vehicle, as will be readily appreciated by those skilled in the art.

The airship is preferably semi-rigid. It preferably uses helium as the lifting gas. It preferably uses electric motors and propellers to control its direction of travel and a buoyancy control system to control its altitude, rate of climb and descent, as discussed in further detail below.

It is preferably configured to perform up to multi-month missions and for such purposes is preferably provided with solar panels 2 for harvesting electricity during daylight hours. Batteries are preferably provided to store the generated electricity, wherein the batteries can be used to power all systems, payload and the electric motors during night hours.

A normal mission profile may involve the airship departing from an operating base and climbing to the desired operating altitude. The climb may take approximately 600 minutes. Once at the operating altitude, the airship will be positioned to the desired area of operation where it substantially maintains its altitude and position. During this time it performs its commercial operations i.e. operating its communications payload, and providing the communications relay service in the desired band(s).

The operating area will typically be over sparsely populated rural areas or over water.

During the climb and descent phase, in order to minimise potential disruption to manned aircraft operating below 15 km, the routes will be planned to remain clear of established airways structures. Time spent below 15 km will be limited to climb or descent and may preferably occur at night when manned aircraft operations are at their most infrequent.

Considering the airship in further detail, as discussed, it is preferably a semi-rigid gas airship.

It may comprise a stiff keel 3 supporting a main envelope 4 along at least a portion of its length direction/longitudinal axis. The stiff keel 3 preferably extends along a longitudinal centreline of the main envelope/hull on an underside thereof. It need not extend along the entire length of the outer envelope and it is most preferably shorter than the main envelope, as best seen in FIG. 1B.

The longitudinal keel 3 is used to provide structural rigidity to the envelope. It preferably houses batteries, avionics and radio frequency (RF) units, which form part of the communications payload. It further provides an attachment point for any desired payloads. It also provides a structure to which a mounting structure for the propulsion system may be attached.

The keel 3 is not particularly limited in form or construction, however, in a preferred arrangement, as shown, it comprises a welded aluminium structure. It could otherwise be formed using carbon fibre, or otherwise.

Whilst not to be limited as such, the steering and propulsion system is preferably configured in accordance with the depicted arrangement. The steering and propulsion system comprises four electric motors, which are spaced from one another to provide a pair of vertically spaced motors on either side of the hull, and which each drive a fixed pitch propeller. The combination of each motor and propeller may be considered to define a propulsion unit 5. The propulsion units 5 are illustrated schematically in the figures. The electric motors are preferably brushless.

The motors/propellers are preferably mounted such that their thrust vectors are fixed in the horizontal, i.e., fixed parallel to the longitudinal axis of the outer envelope/hull 4. The motors/propellors are all capable of forward and reverse thrust and are independently controlled. In the present arrangement, as is preferred, there are four motors provided, as follows:
Motor 1: Port side upper
Motor 2: Port side lower
Motor 3: Starboard upper
Motor 4: Starboard lower

The four motors in such configuration provide sufficient thrust at all operating altitudes to perform the required manoeuvring through a use of differential and asymmetric thrust. Independent motor control is achieved under the control of an electronic control system. A turn command will result in asymmetric thrust between port and starboard motors. A pitch command will result in differential thrust between upper and lower motors. A speed change command will result in a thrust change across all motors.

It should be appreciated that in alternative arrangements, the motors and/or propellors may be alternatively configured. For example, there may be additional motors provided. Regardless of the specific number of motors, the propellers may alternatively comprise variable pitch propellers.

A suitable mounting is provided to support the motors in their desired positions/orientations. The mounting is most preferably attached to/supported by the keel 3. In the present arrangement, the motors are mounted on two substantially vertical pylons 6, which pylons 6 are supported by substantially horizontal support arms 7 that extend in opposed directions from the keel 3 substantially perpendicular to a longitudinal axis of the keel (and hull). The arrangement is such as to provide the discussed vertically spaced pair of motors on either side of the hull. Motors 1 and 2 are provided on the port side and motors 3 and 4 are provided on the starboard side. The support arms 7 and pylons 6 may be unitarily formed or may be formed separately and fastened together. Regardless, they may be formed from a suitable lightweight material. They may be formed from aluminium or carbon fibre, for example.

It has been determined that motors having a maximum power output of 35 kW are suitable. However, alternatively specified motors may be used.

The hull 4 preferably has an outer envelope that is under high pressure to maintain the shape of the airship. Inside the outer envelope, there may be a plurality of inner envelopes used to contain the gas, most preferably helium, which provides the necessary buoyancy. In a preferred example, there are three inner envelopes provided.

The inner and outer envelopes are each preferably formed from a number of gores 8, wherein each of the gores 8 comprises an appropriately shaped piece of material. The inner and outer layers may each comprise 20 or more gores. Adjacent gores 8 of any of the inner and outer envelopes may be joined to one another using a double-sided adhesive tape lap join 9. A single sided tape 10 may additionally be used to secure the outer free edge of the seam, as shown in FIG. 3.

It is preferable, for control of buoyancy that one or more ballonets (not shown) are provided. The ballonets comprise air bags. They are preferably contained within the outer envelope. In a preferred embodiment, a pair of ballonets is provided, one forward and one aft.

Fins 11 are attached to the aft envelope to provide dynamic and static stability. There are preferably four fins 11, as shown, with two vertical fins 11a and two horizontal fins 11b in a cross formation. They are preferably constructed of the outer envelope material and inflated by the super-pressure maintained within the outer envelope. The fins may be stabilised using cords, of Kevlar or other suitable material, attached to the ends of the fins at one end and to the envelope on the other. There may further be provided cords that connect the tips of each fin to both adjacent fins, which again may be Kevlar or otherwise.

The buoyancy of the airship is preferably controlled by a buoyancy control system, which injects or ejects air from a plurality of ballonets that sit inside the outer envelope of the airship. The inflation/deflation of the ballonets will result in a change in the proportion of air and helium contained within the outer envelope. Increasing the proportion of air increases the average density of the gas contained in the airship, reducing its buoyancy. Ejecting air has the opposite effect, increasing the buoyancy of vehicle allowing it to gain altitude. The total volume of the envelope preferably remains almost constant.

The solar panels, which are preferably arranged on the upper surface of the airship, will, as discussed, be configured to provide sufficient electrical harvesting during daylight operating hours to enable propulsion and other system batteries to be sufficiently charged for operations overnight before commencing a new charging cycle the next day. The solar panels may, for example, have a surface area of 100 m2 or more.

Power is preferably derived from rechargeable batteries, which may take any suitable form.

Each motor may have its own individual power system comprising a battery and an Electronic Speed Controller (ESC). The ESCs are controlled by the control system.

Additional independent battery packs may be provided to provide power for the other electronic systems.

Whilst the dimensions of the airship are not particularly limited, a particularly preferred arrangement is configured as follows:
Length: 99 m
Span: 24.5 m
Height: 19.1 m
Maximum take-off and landing mass: 1965 kg

With reference to FIG. 5, an exemplary control system architecture is shown. The control system as stated comprises one or more sensors for monitoring the position and orientation of the vehicle, and is configured to control operation of the steering and propulsion system comprising the electric motors. The one or more sensors in the present arrangement comprise at least one accelerometer for determining orientation, and at least one GPS sensor for determining position. In the present arrangement there are a plurality of accelerometers provided and a plurality of GPS sensors. This need not be the case in alternative arrangements. Moreover, alternative and/or additional sensors for monitoring the position and/or orientation of the vehicle may be included

Air data sensors, such as but not limited to air speed and side slip sensors, and antennas intended for ground communications are preferably located on the keel. Antennas requiring satellite reception, such as but not limited to GPS and ADS-B antennas, are preferably located on the motor mounting pylons.

Navigation is preferably performed via a GPS system that comprises the at least one GPS sensor. It is preferable that a primary GPS system is provided that is supported by a redundant backup GPS system. The GPS system(s) preferably provide position information to an autopilot which sends the telemetry to a ground control.

A completely independent means of monitoring airship position is preferably provided by an ADS-B (Automatic Dependent Surveillance-Broadcast) system. This system utilises a dedicated GPS receiver and barometer. Information transmitted by the ADS-B system is received by a space-based ADS-B receiver network and sent to the ground control via an Internet link.

The control system preferably comprises primary and redundant backup autopilots. These preferably comprise the SC2 Autopilot available from Callen-Lenz Group.

Considering the present, exemplary arrangement, following launch, the vehicle will navigate under control of the autopilot to a predetermined location using the GPS and ADS-B systems. Upon reaching the desired location, the vehicle will loiter at that location, maintaining a substantially constant position by suitable operation of the buoyancy and propulsion systems under control of the autopilot. The substantially constant position preferably comprises any location within 500 m from a predetermined point in space. From the substantially constant position, the communications payload onboard the vehicle will provide a communications relay service with a ground station within one or more or all of the Ku band, the Ka band, the C band, the K band, or the X band. The vehicle may loiter at the predetermined location for any desired length of time. As discussed, this may, for example, be at least 12 hours. It could, however, be several months.

For ground antennas the telecoms payload behaves as a GEO satellite, meaning that the vehicle must stay at the same location while it is in operation. Since the vehicle is subjected to wind forces and changes in air density, the flight control system ensures that the vehicle loiters around the desired operation point. A vehicle loitering control ensures that the vehicle distance to the desired loitering point never exceeds a predetermined maximum distance, which, as discussed, may be 500 m.

The loitering control uses the three degrees of freedom as discussed above:
1) Altitude (z-axis displacement) is controlled using the buoyancy control system.
2) Yaw (z-axis rotation) is controlled using the electric motors with the motors on one side creating forward thrust and the motors on the opposite side creating backwards thrust.
3) Forward and reverse (x-axis displacement) is controlled with the electric motors. All four motors generate either forward or backward thrust to create forward or reverse motion respectively.

An exemplary control arrangement may be as follows:

A first, outer, sphere may be determined of a predetermined size with its centre at the predetermined (loitering) point. It may, for example, have a radius of up to 500 m from the predetermined point. A second, inner sphere, may further be determined having a smaller radius, again with its centre at the predetermined (loitering) point. It may, for example, have a radius of up to 250 m from the predetermined point. The position of the vehicle in relation to the predetermined point in space, and thereby in relation to the spheres, is preferably constantly monitored. Whilst in the present arrangement both spheres are utilised, there may be arrangements provided in which only the first sphere is used.

i) When it is determined that the vehicle is within the inner (second) sphere, no action is necessary, the steering and propulsion system is shut off. However, the buoyuancy control system remains engaged to keep the vehicle within altitude limits imposed by the inner (second) sphere.

ii) When it is determined that the vehicle is outside the inner (second) sphere but remains within the outer (first) sphere—the airship rotates around its main axes to keep pointing to the predetermined point in space (i.e. the centre of the spheres) and uses forward or reverse thrust to return to the inner sphere.

iii) When it is determined that the vehicle is outside the outer sphere—the airship engages a navigation mode to return to the inner sphere along a path comprising one or more intervening waypoints.

The arrangement is accordingly preferably such that the control system implements a first control protocol at (ii) above, a second control protocol at (iii) above, and a third control protocol at (i) above. The first, second and third control protocols are preferably different to one another, as indicated.

According to the first control protocol, the vehicle is rotated, preferably substantially on the spot, to acquire a desired orientation (pointing to the predetermined point) before being propelled forward while steering, as necessary, to continuously point towards the predetermined spot.

The arrangement is such that there is no thrust applied, which would act to propel the vehicle from its starting point, until the vehicle has been rotated. It must be noted that rotation may occur by the application of differential thrust. Thrust to propel the vehicle following rotation may comprise linear or asymmetric thrust.

The first control protocol may additionally or alternatively comprise varying thrust in dependence on the distance of the vehicle from the predetermined point.

FIG. 5 illustrates, in plan view, an operational sequence under the first control protocol.

In image A of the sequence, the vehicle has drifted from within the inner (second) sphere 102 to outside of the inner sphere. It remains within the outer (first) sphere 101.

In image B of the sequence, the first control protocol is implemented. The vehicle is rotated about one or more of its axes. No thrust (linear or asymmetric) is applied to propel the vehicle from its starting point. The rotation is preferably implemented by differential thrust, as discussed above. By the rotation, the vehicle 1 is pointed to the centre of the spheres 101, 102.

In image C of the sequence, the first control protocol continues, following its rotation at B, the steering and propulsion system is used to provide appropriate thrust (preferably linear thrust) to propel the vehicle 1 towards the centre of the spheres 101, 102. The thrust will be controlled to stop the vehicle within the inner sphere 102.

Once within inner sphere 102, the third control protocol may be implemented.

According to the second control protocol, a navigation path to the predetermined point is set, which comprises one or more intervening waypoints, and operating the propulsion and steering system to follow the navigation path. With such an arrangement, in contrast to the second control protocol, travel of the vehicle in navigation mode does not require that the vehicle continuously faces towards the next waypoint.

Note that the second control protocol may be the same control protocol that is adopted on the initial journey of the vehicle, following launch, from the ground to the first sphere.

FIGS. 6a and 6b show, in plan view, possible navigation paths under the second control protocol. The paths are purely exemplary and in no way limiting. As discussed, one or more intervening waypoints 103 are provided. In the exemplary paths two intervening waypoints 103a, 103b are shown. The vehicle may be propelled/steered towards the waypoints, without needing to hit the waypoints, as seen in FIG. 6a, or may be propelled/steered to hit the waypoints, as seen in FIG. 6b. As is clear from the figures, in either arrangement, in contrast to the first control protocol, the vehicle does not continuously point to the next waypoint, nor to the point defining the final destination.

According to the third control protocol, in contrast to the first and second control protocols discussed above, the vehicle is not propelled away from its starting point.

The communications payload is preferably supported by the keel. The communications payload may comprise a conventional geosynchronous orbit satellite transponder, appropriately configured to suit its use in the vehicle taking into account the desired operating height, and appropriate receipt and transmission frequencies and powers for mimicking of a ‘bent-pipe’ geosynchronous orbit satellite transponder at ground level.

An antenna array of the communications payload is preferably mounted to the keel on an underside of the vehicle via a three-axis gimbal. The three-axis gimbal will maintain a substantially constant orientation of the antenna array relative to the ground station during use.

The antenna array may comprise a plurality of via-fed patch array antennas. The antennas are preferably mounted in a desired array, dependent on operating location and requirements. The antennas may be mounted on a support that is attached to the gimbal. The antennas may be arranged in an annular array. The support may be annular to suit the array. A first plurality of the antennas of the array may be configured to transmit signals and a second plurality of the antennas of the array may be configured to receive signals. The ground transmit area covered by the vehicle may be modified as necessary by switching off one or more antennas of the array.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

Although certain example embodiments of the invention have been described, the scope of the appended claims is not intended to be limited solely to these embodiments. The claims are to be construed literally, purposively, and/or to encompass equivalents.

We claim:

1. A lighter than air vehicle, comprising:
a steering and propulsion system, and
a control system, the control system comprising one or more sensors for monitoring the position and orientation of the vehicle and being configured to control operation of the steering and propulsion system based on sensed data,
wherein the control system is configured to substantially maintain the vehicle within a predetermined distance of a predetermined point by:
defining a first sphere having the predetermined point at its centre;
monitoring the orientation of the vehicle and its position relative to the first sphere; and
controlling the steering and propulsion system in dependence on the position of the vehicle relative to the first sphere, wherein the control system is configured to implement a first control protocol when the vehicle is within the first sphere, and the control system is configured to implement a second control protocol, which is different to the first control protocol, when the vehicle is outside the first sphere.

2. The lighter than air vehicle as claimed in claim 1, wherein the control system is configured to define a second smaller sphere having the predetermined point at its centre, and to control the steering and propulsion system in dependence on the position of the vehicle relative to the first and second spheres.

3. The lighter than air vehicle as claimed in claim 2, wherein the control system is configured to implement a third control protocol when the vehicle is within the second sphere.

4. The lighter than air vehicle as claimed in claim 3, wherein the third control protocol is different to the first control protocol, and/or wherein the third control protocol is different to the second control protocol.

5. The lighter than air vehicle as claimed in claim 1, wherein the first control protocol comprises operating the steering and propulsion system to rotate the vehicle about one or more of its axes to point the vehicle towards the predetermined point, and subsequently operating the steering and propulsion system to propel the vehicle towards the predetermined point.

6. The lighter than air vehicle as claimed in claim 1, wherein the second control protocol comprises setting a navigation path to the predetermined point, which comprises one or more intervening waypoints, and operating the propulsion and steering system to follow the navigation path.

7. The lighter than air vehicle as claimed in claim 1, wherein the second control protocol comprises varying thrust in dependence on the distance of the vehicle from the predetermined point.

8-10. (canceled)

11. The lighter than air vehicle as claimed in claim 1, wherein the steering and propulsion system comprises a plurality of independently controlled electric motors, each of which drives its own propeller.

12. The lighter than air vehicle as claimed in claim 11, wherein the steering and propulsion system is configured to steer the vehicle by differential control of two or more of the electric motors.

13. The lighter than air vehicle as claimed in claim 11, wherein at least two vertically spaced electric motors are provided either side of a longitudinal centreline of a hull of the vehicle.

14. The lighter than air vehicle as claimed in claim 11, wherein the vehicle comprises a rigid keel extending in a longitudinal direction, which supports a motor mount that supports the electric motors.

15. The lighter than air vehicle as claimed in claim 1, wherein stabilising fins are attached to a rear of the vehicle.

16. The lighter than air vehicle as claimed in claim 15, wherein there are four fins provided, which comprise two vertical fins and two horizontal fins.

17. The lighter than air vehicle as claimed in claim 15, wherein the fins are inflatable.

18. The lighter than air vehicle as claimed in claim 1, further comprising a buoyancy control system, which comprises a plurality of inflatable ballonets, which are contained within an outer envelope of the vehicle, and an envelope pressure control system, which is arranged to inject or eject air from the ballonets.

19. The lighter than air vehicle as claimed in claim 18, wherein at least one ballonet is provided adjacent a front of the vehicle and at least one ballonet is provided adjacent a rear of the vehicle.

20. The lighter than air vehicle as claimed in claim 19, wherein the envelope pressure control system is arranged to independently control inflation/deflation of the front and rear ballonets.

21. The lighter than air vehicle as claimed in claim 1, further comprising a communications payload that comprises an antenna array, wherein the antenna array is mounted to the vehicle via a three-axis gimbal for maintaining a substantially constant orientation of the antenna array relative to the earth.

22. The lighter than air vehicle as claimed in claim 21, wherein the communications payload is configured for providing a communications relay service with a ground station within one or more or all of the C band, the X band, the Ku band, the K band, and the Ka band.

23. A communications system, comprising:
at least one of the lighter than air vehicle, according to claim 22, which, in use, is maintained at a substantially constant position at an altitude of 15 km to 22 km.
